(19) United States
(12) Patent Application Publication
(10) Pub. No.: US 2008/0101578 A1
(43) Pub. Date: May 1, 2008

(54) METHOD AND SYSTEM FOR GUARDIAN APPROVAL OF COMMUNICATIONS

(75) Inventors: MARK A. BARROS, WELLINGTON, FL (US); VON A. MOCK, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/555,377

(22) Filed: Nov. 1, 2006

(51) Int. Cl. H04M 3/42

(52) U.S. Cl. 379/211.02

(57) ABSTRACT

A method (10) and system (20, 30, or 200) of guardian approval of communications where a guardian phone serves as a master phone (24) to at least one slave phone (26 or 28) can include the steps of forwarding (2) an unknown incoming call to a slave phone to the master phone, enabling (4) the master phone to approve the unknown incoming call, and routing (6) the unknown incoming call to the slave phone when the master phone approves the unknown call. The method can further route (8) an unknown outgoing call from a slave phone to the master phone, enable (9) the master phone to approve the unknown outgoing call to a third party, and route (11) the unknown outgoing call to the third party when the master phone approves the unknown outgoing call.

### FIELD

This invention relates generally to communication systems, and more particularly to a method and system for approval of communications by a guardian.

### BACKGROUND

Cellular phones have become ubiquitous to the point where young children and adults alike stay in contact with one another. Parents frequently justify the purchase of a new cellular phone for their children as a way to keep in contact with them from a personal and family security aspect. Children and teens are spending more time away from their parents and need the capability to contact their parent or guardian in the event of an emergency or for a sense of comfort or well being.

Ubiquitous communication devices can be a double-edged sword. On one hand, they can provide a bidirectional lifeline to both parent and child. A child with a cellular phone is accessible to his or her parent regardless of distance and time. Likewise, a parent is accessible to their child. Unfortunately, this also means that the child is also exposed to others who may wish to do them harm and take advantage of them. Sexual predators, identification thieves, and unscrupulous marketers search out young children and even elderly individuals in hopes of alluring them to a defenseless state or in hopes of shamelessly taking advantage of them.

There are a number of applications on the Internet that limit exposure of a child or teen to activity of individuals that may cause harm to them. Some examples include AOL Guardian, Cybersitter software and numerous email add-ons that prevent access to content that is deemed inappropriate to the individual. However, these applications fail to provide a real time mobile environment for the parent or guardian to monitor and therefore approve access. Wire line phones can be subscribed to block certain outgoing or incoming area codes. There are even options on mobile phones that determine if an application on the phone is allowed to perform. Other attempts at resolving other problems such as providing preprogrammed one-touch dialing buttons (insuring callers can make necessary calls to a predetermined number of locations) can help a small business owner manage communications expenses and avoid incurring unauthorized expenses, but such devices would not likely become ubiquitous and would unnecessarily limit the functionality of communication devices.

### SUMMARY

Embodiments in accordance with the present invention can enable a mediating parent or guardian to decide if an incoming or outgoing call, contact or both are allowed to go through. Embodiments herein enable devices to retain substantial open connectivity while enabling the monitoring or prevention of callers or calls that mean ill will towards an individual.

In a first embodiment of the present invention, a method of guardian approval of communications where a guardian phone serves as a master phone to at least one slave phone can include the steps of forwarding an unknown incoming call to a slave phone to the master phone, enabling the master phone to approve the unknown incoming call, and routing the unknown incoming call to the slave phone when the master phone approves the unknown call. The method can further include the steps of routing an unknown outgoing call from a slave phone to the master phone, enabling the master phone to approve the unknown outgoing call to a third party, and routing the unknown outgoing call to the third party when the master phone approves the unknown outgoing call. The method can further include the step of recognizing the unknown outgoing call by the master phone as an approved called party and subsequently enabling outgoing calls from the slave phone to the approved called party without forwarding the outgoing call to the master phone. The method can also include the step of recognizing the unknown incoming call by the master phone as an approved caller and subsequently enabling incoming calls from the approved caller to the slave phone without forwarding the approved caller to the master phone. The method can also enable the master phone to override existing settings such that all incoming and outgoing calls go through the master phone. The method can also periodically generate or selectively generate a report of unknown incoming calls or unknown outgoing calls to or from the slave phone at the master phone. The method can also maintain a master profile for access and control for slave devices under the master phone at a server. The method can also present an indication on the slave device that the slave device is being monitored by the master device or alternatively or optionally present an indication on the master device of a particular call or caller being monitored.

In a second embodiment of the present invention, a system of guardian approval of communications can include a guardian phone serving as a master phone to at least one slave phone, and a processor operatively coupled to the master phone and the slave phone. The processor can be programmed to forward any unknown incoming call to a slave phone to the master phone, enable the master phone to approve the unknown incoming call, and route the unknown incoming call to the slave phone when the master phone approves the unknown call. The processor can be further programmed to route an unknown outgoing call from a slave phone to the master phone, enable the master phone to approve the unknown outgoing call to a third party, and route the unknown outgoing call to the third party when the master phone approves the unknown outgoing call. The processor can be further programmed to recognize the unknown incoming call and designate the unknown incoming call by the master phone as an approved caller and subsequently enables incoming calls from the approved caller to the slave phone without forwarding the approved caller to the master phone. The processor can be programmed to designate the unknown outgoing call as a call to an approved called party by the master phone and subsequently enable outgoing calls from the slave phone to the approved called party without forwarding the outgoing call to the master phone. The processor can also enable the master phone to override existing settings such that all incoming and outgoing calls go through the master phone. The system can periodically generate or selectively generate a report of unknown incoming calls or unknown outgoing calls to or from the slave phone at the master phone. The system can also maintain a master profile for access and control for slave devices under the master phone at a server. The system can also present an indication on the slave device that the slave device is being monitored by the master device.

In a third embodiment of the present invention, a portable wireless communication unit having a system of guardian approval can include a transceiver and a processor operatively coupled to the transceiver. The processor can be programmed to forward any unknown incoming call to the transceiver to a master phone and accept the unknown incoming call if the master phone approves the unknown incoming call and designates the unknown incoming call as an approved call. The processor can be further programmed to route an unknown outgoing call from the transceiver to the master phone and enable the transceiver to route the unknown outgoing call to a third party when the master phone approves the unknown outgoing call to the third party and designates the unknown outgoing call as an approved call. The processor can further be programmed to recognize approved calls and subsequently enables incoming calls from an approved caller to the slave phone without forwarding the approved caller to the master phone. The processor can also be programmed to recognized approved calls to third parties and subsequently enables outgoing calls from the transceiver to an approved caller without forwarding the approved call to the master phone.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method of guardian approval of communications accordance with an embodiment of the present invention.

FIG. 2 is an illustration of a system for guardian approval of communications in accordance with an embodiment of the present invention.

FIG. 3 is an illustration of another system for guardian approval of communications in accordance with an embodiment of the present invention.

FIG. 4 is a user interface or display illustrating an icon indicating a monitoring mode in accordance with an embodiment of the present invention.

FIG. 5 is a database of routing instructions in accordance with an embodiment of the present invention.

FIG. 6 is a block diagram of a system for guardian approval of communications in accordance with another embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

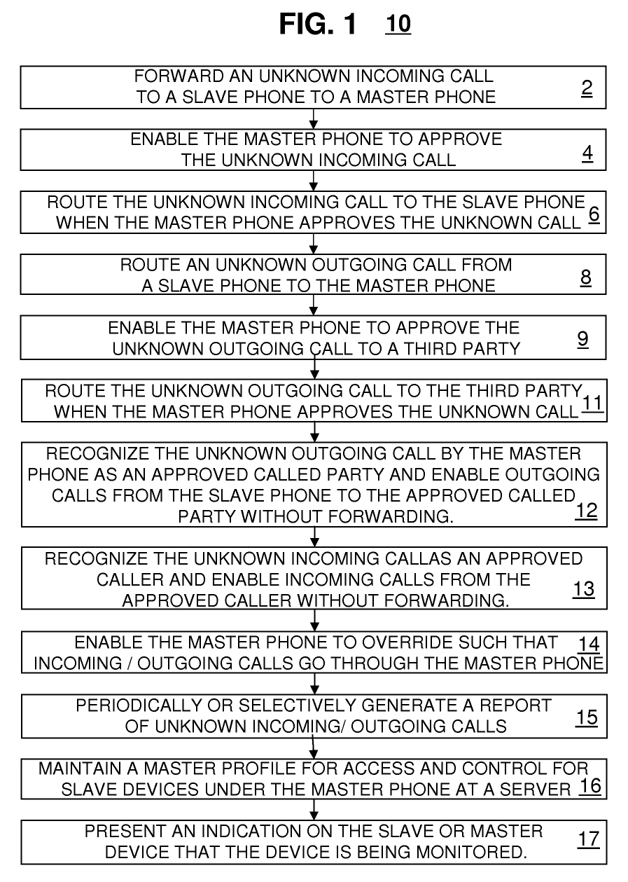

Referring to FIG. 1, a flow chart illustrates a method 10 of guardian approval of communications where a guardian phone serves as a master phone to at least one slave phone. The method 10 can include the step 2 of forwarding an unknown incoming call to a slave phone to the master phone, enabling the master phone to approve the unknown incoming call at step 4, and routing the unknown incoming call to the slave phone when the master phone approves the unknown call at step 6. The method 10 can further include the step 8 of routing an unknown outgoing call from a slave phone to the master phone, enabling the master phone to approve the unknown outgoing call to a third party at step 9, and routing the unknown outgoing call to the third party when the master phone approves the unknown outgoing call at step 11. The method 10 can further include the step 12 of recognizing the unknown outgoing call by the master phone as an approved called party and subsequently enabling outgoing calls from the slave phone to the approved called party without forwarding the outgoing call to the master phone. The method 10 can also include the step 13 of recognizing the unknown incoming call by the master phone as an approved caller and subsequently enabling incoming calls from the approved caller to the slave phone without forwarding the approved caller to the master phone. The method 10 can also enable the master phone to override existing settings such that all incoming and outgoing calls go through the master phone at step 14. Note, such existing settings can be at the slave phone or at the master phone or elsewhere. The method at step 15 can also periodically generate or selectively generate a report of unknown incoming calls or unknown outgoing calls to or from the slave phone at the master phone. The method can also maintain a master profile for access and control for slave devices under the master phone at a server at step 16. The method can also present an indication on the slave device that the slave device is being monitored by the master device at step 17.

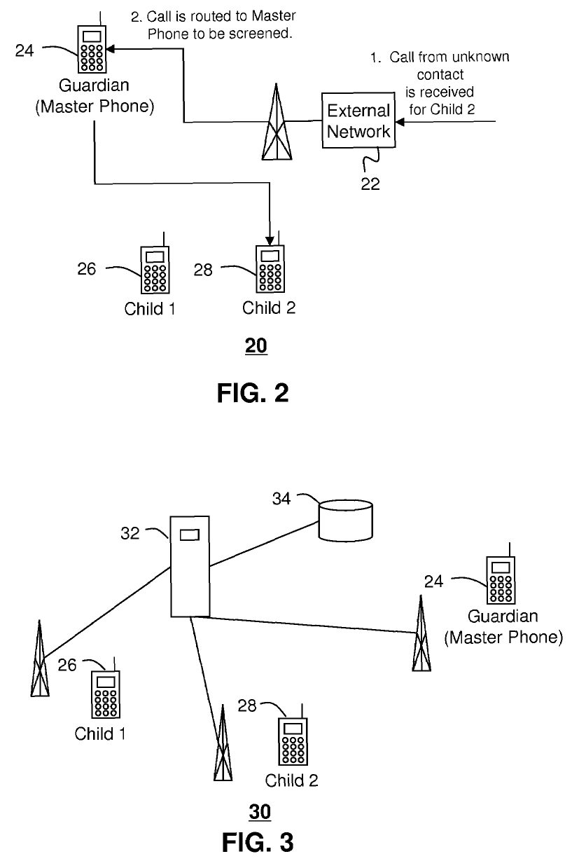

Referring to FIG. 2, a system 20 can include an external communication network 22 such as a wireless or wireline network, a guardian or master phone 24, and at least one slave or child phone 26 or 28. The embodiments herein can route all “unknown” calls to a master phone such as phone 24 that is destined to or leaving from a slave phone for approval or monitoring by the aster phone 24. In FIG. 1, a unknown caller makes a call to slave or child phone 28. The call is routed to the master phone 24 first to enable the master phone 24 to screen the call from the unknown caller. The master phone 24 can examine the caller ID information along with information about who the call should be routed to and can choose to allow the call to be routed to the child phone 28 by pressing a button or can alternatively take a moment to talk to the individual calling to gain more information about who is calling and then forwarding or rejecting the incoming call. Referring to FIG. 3, a system 30 for guardian approval can further include a server 32 and database 34 coupled to a communication network that communicates with the master phone 24 and slave or child phones 26 and 28 of FIG. 2

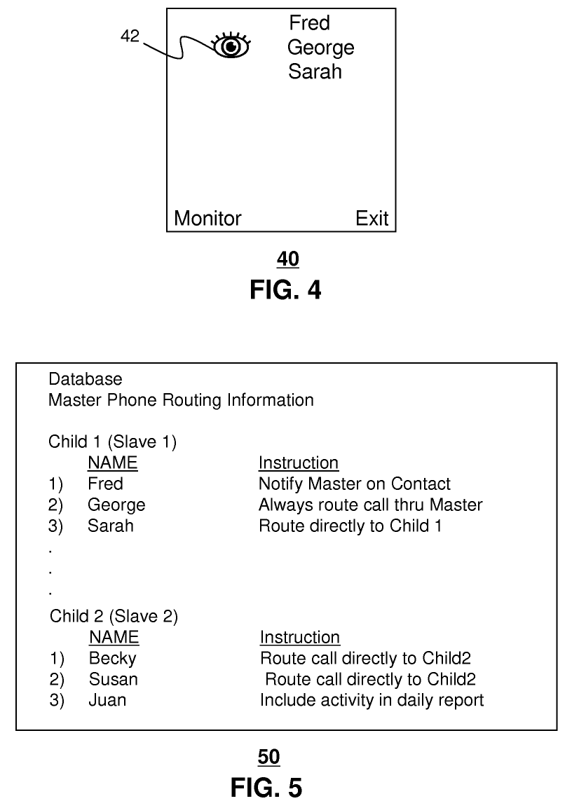

In most instances, the Slave mobile devices will be able to initiate outgoing calls or receive incoming calls from the newly added approved contact without having to through the Master Phone. However, there may be times when the adult or guardian may want to monitor the time two individuals spend talking. As noted in the method above, the master phone 24 may also choose to override all settings and may choose to receive all incoming and outgoing calls to any of the slave devices 26 or 28. The master phone 24 may also choose to receive a call record for each slave device that they administrator to either periodically or selectively received a report. The report can also be selectively triggered based on a call event as well. The periodic report interval may be daily, weekly, monthly, or set to some other interval. In addition, the master phone 24 may choose to receive real time notification for certain calls that have been already pre-approved by the master device for the purpose of real time monitoring. As shown in a user interface or display 40 of FIG. 4, the master phone can receive a notification and screen that depicts the state of a particular slave device (e.g., George) and have the opportunity to change the call to a three-way call, a group call or to monitor such call. The “eye” symbol 42 can be used in either the master phone or the slave phone. In the master phone, the symbol 42 can indicate which contact is currently active and in communication with a particular slave device. In the slave phone, the symbol 42 can be optionally used to indicate that the phone is being monitored by the master phone. In other embodiments, this real time approval mechanism can be applied to Instant Messaging Buddy Lists, PTT Over Cellular social groups, and Online Communities such as MySpace.

Referring again to FIG. 3 as well as a database entry 50 as illustrated in FIG. 5, the system 30 for guardian approval can include the server 32 and database 34 coupled to the communication network that communicates with the master phone 24 and slave or child phones 26 and 28. The database entry or entries can be maintained in a server or can be maintained in the master phone itself. The database entries can include master phone routing information used for each slave device that the master phone administers. For example, a first slave phone can have entries for Fred, George, and Sarah and corresponding routing instructions when Fred, George or Sarah calls the first slave phone. Likewise, a second slave phone can have entries for Becky, Susan and Juan and corresponding routing instructions for when they call the second slave phone. In this manner, the embodiments herein provide safety and security for children, teens, or other vulnerable individuals that may unknowingly be in the crosshairs of one more individuals wanting to do harm.

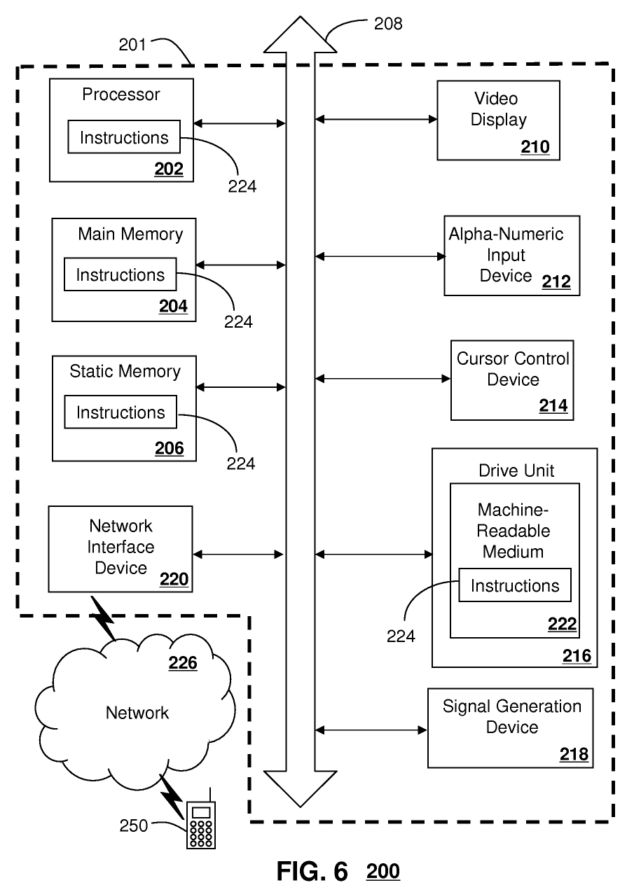

FIG. 6 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of guardian approval of communications where a guardian phone serves as a master phone to at least one slave phone, the method comprising the steps of:
forwarding an unknown incoming call to a slave phone to the master phone;
enabling the master phone to approve the unknown incoming call; and
routing the unknown incoming call to the slave phone when the master phone approves the unknown call.

2. The method of claim 1, wherein the method further comprises the steps of:
routing an unknown outgoing call from a slave phone to the master phone;
enabling the master phone to approve the unknown outgoing call to a third party;
routing the unknown outgoing call to the third party when the master phone approves the unknown outgoing call.

3. The method of claim 1, wherein the method further comprises the step of recognizing the unknown incoming call by the master phone as an approved caller and subsequently enabling incoming calls from the approved caller to the slave phone without forwarding the approved caller to the master phone.

4. The method of claim 2, wherein the method further comprises the step of recognizing the unknown outgoing call by the master phone as an approved called party and subsequently enabling outgoing calls from the slave phone to the approved called party without forwarding the outgoing call to the master phone.

5. The method of claim 1, wherein the method further comprises the step of enabling the master phone to override existing settings such that all incoming and outgoing calls go through the master phone.

6. The method of claim 1, wherein the method further comprises the step of periodically generating or selectively generating a report of unknown incoming calls or unknown outgoing calls to or from the slave phone at the master phone.

7. The method of claim 1, wherein the method further comprises the step of maintaining a master profile for access and control for slave devices under the master phone at a server.

8. The method of claim 1, wherein the method further comprises the step of presenting an indication on the slave device that the slave device is being monitored by the master device or the step of presenting an indication on the master device of a monitoring of a particular caller.

9. A system of guardian approval of communications, comprising:
a guardian phone serving as a master phone to at least one slave phone; and
a processor operatively coupled to the master phone and the slave phone, the processor being programmed to:
forward any unknown incoming call to a slave phone to the master phone;
enable the master phone to approve the unknown incoming call; and
route the unknown incoming call to the slave phone when the master phone approves the unknown call.

10. The system of claim 9, wherein the processor is further programmed to:
route an unknown outgoing call from a slave phone to the master phone;
enable the master phone to approve the unknown outgoing call to a third party; and
route the unknown outgoing call to the third party when the master phone approves the unknown outgoing call.

11. The system of claim 9, wherein the processor is further programmed to recognize the unknown incoming call and designate the unknown incoming call by the master phone as an approved caller and subsequently enables incoming calls from the approved caller to the slave phone without forwarding the approved caller to the master phone.

12. The system of claim 10, wherein the processor is further programmed to designate the unknown outgoing call as an approved called party by the master phone and subsequently enable outgoing calls from the slave phone to the approved called party without forwarding the outgoing call to the master phone.

13. The system of claim 9, wherein the processor is further programmed to enable the master phone to override existing settings such that all incoming and outgoing calls go through the master phone.

14. The system of claim 9, wherein the processor is further programmed to periodically generate or selectively generate a report of unknown incoming calls or unknown outgoing calls to or from the slave phone at the master phone.

15. The system of claim 9, wherein the processor is further programmed to maintain a master profile for access and control for slave devices under the master phone at a server.

16. The system of claim 9, wherein the processor is further programmed to present an indication on the slave device that the slave device is being monitored by the master device.

17. A portable wireless communication unit having a system of guardian approval, comprising:
a transceiver; and
a processor operatively coupled to the transceiver, wherein the processor is programmed to:
forward any unknown incoming call to the transceiver to a master phone; and
accept the unknown incoming call if the master phone approves the unknown incoming call and designates the unknown incoming call as an approved call.

18. The portable wireless communication unit of claim 17, wherein the processor is further programmed to:
route an unknown outgoing call from the transceiver to the master phone; and
enable the transceiver to route the unknown outgoing call to a third party when the master phone approves the unknown outgoing call to the third party and designates the unknown outgoing call as an approved call.

19. The portable wireless communication unit of claim 17, wherein the processor is further programmed to recognize approved calls and subsequently enables incoming calls from an approved caller to the slave phone without forwarding the approved caller to the master phone.

20. The portable wireless communication unit of claim 18, wherein the processor is further programmed to recognize approved calls to third parties and subsequently enables outgoing calls from the transceiver to an approved caller without forwarding the approved call to the master phone.
